(19) United States
(12) Patent Application Publication
(10) Pub. No.: US 2017/0233097 A1
(43) Pub. Date: Aug. 17, 2017

(54) UNMANNED AERIAL VEHICLE FLYING METHOD AND UNMANNED AERIAL VEHICLE FLYING SYSTEM

(71) Applicants: Inventec Appliances (Pudong) Corporation, Shanghai (CN); Inventec Appliances Corp., New Taipei City (CN)

(72) Inventor: Chuan-Yi Chang, Taipei (TW)

(21) Appl. No.: 15/280,134

(22) Filed: Sep. 29, 2016

(30) Foreign Application Priority Data
Feb. 15, 2016 (CN) 201610086318.5

(51) Int. Cl. B64D 45/00; B64C 39/02; G08G 5/00

(52) U.S. Cl. CPC B64D 45/0015; G08G 5/003; G08G 5/0069; B64C 39/024; H04W 4/008

(57) ABSTRACT

An unmanned aerial vehicle (UAV) flying method for helping an UAV flying to a location of an owner of the UAV or flying to a predetermined place includes the following steps of: triggering the UAV into a hijacked mode; ascertaining if the UAV is capable of flying or not; the UAV flying to the location of the owner or to the predetermined place if the UAV is capable of flying; and, the UAV sending a distress signal to the owner if the UAV is not capable of flying. Therefore, the UAV is capable of flying back or sending information after entering the hijacked mode, so as to avoid or lower the loss caused by losing the UAV or the UAV being captured by the captor.

### PRIORITY CLAIM

This application claims the benefit of China Patent Application No. 201610086318.5 filed on Feb. 15, 2016, the entire disclosure of which is hereby incorporated by reference as if fully set forth herein.

### FIELD OF THE INVENTION

This invention relates to an unmanned aerial vehicle (UAV) flying method and an UAV flying system, and more particularly, to the UAV flying method and the UAV flying system helping an UAV flying back to a location of an owner of the UAV or to a predetermined place under a hijack mode.

### DESCRIPTION OF THE PRIOR ART

Unmanned Aerial Vehicle (UAV) is a flying vehicle for specific task by remote controlling or auto-guiding technology. Compared to the traditional flying vehicles, UAV has merits of lower operational cost, wider use, and less supporting equipment. UAV was used in the military field at first. Tactical UAV can fly for at least 20 hours, and up to at least 5,486.4 meters height.

Recently, UAV is developed in many fields because of its better adaptation to different environments than that of manned aerial vehicle. Besides military field, UAV is used for scientific observation, disaster relief, cargo transport, or commercial aerial photography in nongovernment fields. UAV includes little distance UAV and short distance UAV. Little UAVs can bear a burden under 5 kg and fly in low height for 5 km. The flying distance of short distance UAV extends to 20 km. These UAVs are called small-UAVs or mini-UAVs, and there is a smaller UAV called Micro Aerial Vehicle (MAV) which has a wingspan under 0.5 m and a flying distance under 2 km. MAV capable of following a person and capturing image of target has been available in the prior art.

The requirements of microminiaturization to UAV rise with the popularization and usage fields of UAV. However, the hijacking probability might also increase with the microminiaturization of UAV. For example, the large UAV for aerial delivery cargos is hard to be captured because of its large size; oppositely, micro-sized UAV could be captured by even a single person with a net. On the other hand, the micro-sized UAV might be influenced easily by the environment to deviate from the predetermined flight path or crash. Once the micro-sized UAV crashes, it is hard to rescue the UAV because it is very hard to find for its small size.

Therefore, a novel UAV flying method or system for helping an UAV returning or sending information about the present position of UAV should be provided to solve the problems in the prior art.

### SUMMARY OF THE INVENTION

One of the scopes of the present invention is to provide an Unmanned Aerial Vehicle (UAV) flying method for helping an UAV flying back to a location of an owner or flying to a predetermined place. According to an embodiment of the present invention, the UAV flying method includes the following steps: triggering the UAV into a hijacked mode; ascertaining if the UAV is capable of flying or not; and, the UAV flying to the location of the owner or to the predetermined place if the UAV is capable of flying.

In this embodiment, the UAV starts to fly back to the location of the owner or to the predetermined place when the UAV is under the hijacked mode and capable of flying. The UAV could be triggered into the hijacked mode by a triggering signal sent from the owner, or be triggered into the hijacked mode when the UAV is under an auto-guiding mode but deviates from a predetermined flight path. The step of ascertaining if the UAV is capable of flying or not could proceed via ascertaining the energy level of the UAV and ascertaining if the environment around the UAV is suitable to fly or not. If the energy level of the UAV is higher than a threshold value and the environment around the UAV is suitable to fly, the UAV is ascertained to be capable of flying. Once any of the results of the above-mentioned ascertainments is negative, the UAV is ascertained to be not capable of flying.

In another embodiment, the UAV flying method further includes the following step: the UAV sending a distress signal to the owner if the UAV is not capable of flying, so as to inform the owner the surrounding information around the UAV to assist the rescue.

Another scope of the present invention is to provide an Unmanned Aerial Vehicle (UAV) flying system for helping an UAV flying back to the location of the owner or flying to a predetermined place. According to an embodiment of the present invention, the UAV flying system includes a central control unit configured on the UAV. The central control unit has a hijack processing program and executes a procedure according to the hijack processing program. The central control unit ascertains if the UAV is capable of flying or not according to the hijack processing program. If the UAV is capable of flying, the central control unit controls the UAV to fly to the location of the owner or the predetermined place. If the UAV is not capable of flying, the central control unit controls the UAV to send a distress signal to the owner.

On the advantages and the spirit of the invention, it can be understood further by the following invention descriptions and attached drawings.

### BRIEF DESCRIPTION OF THE APPENDED DRAWINGS

FIG. 1 is a flow chart illustrating an Unmanned Aerial Vehicle (UAV) flying method according to an embodiment of the present invention.

FIG. 2 is a flow chart illustrating an UAV flying method according to another embodiment of the present invention.

FIG. 3 is a flow chart illustrating an UAV flying method according to another embodiment of the present invention.

FIG. 4 is a flow chart illustrating an UAV flying method according to another embodiment of the present invention.

FIG. 5 is a flow chart illustrating an UAV flying method according to another embodiment of the present invention.

FIG. 6 is a schematic diagram illustrating an UAV flying system according to an embodiment of the present invention.

FIG. 7 is a schematic diagram illustrating an UAV flying system according to another embodiment of the present invention.

### DETAILED DESCRIPTION OF THE INVENTION

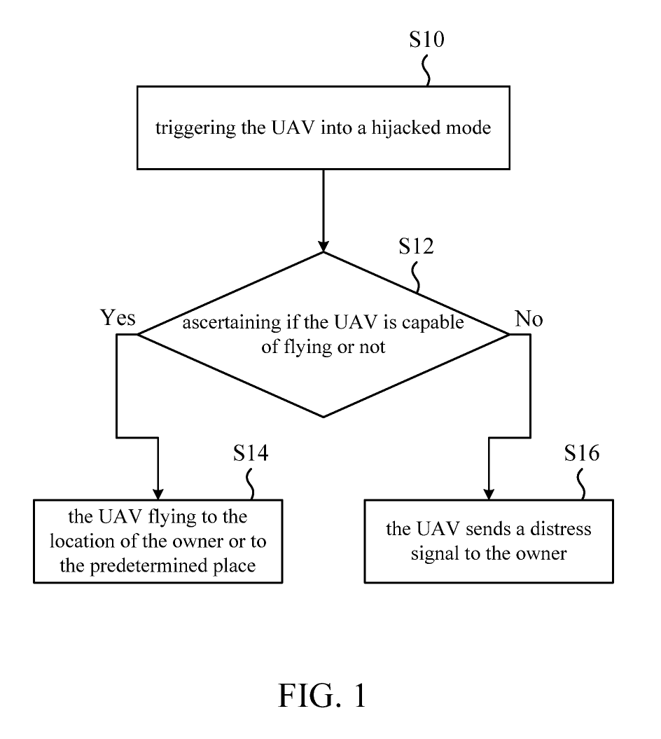

FIG. 1 is a flow chart illustrating an Unmanned Aerial Vehicle (UAV) flying method according to an embodiment of the present invention. The method shown in FIG. 1 can help an UAV flying to the location of the owner of the UAV or to a predetermined place when the UAV is hijacked or lost. The owner could be the person who owns the UAV, the person who controls the UAV, or the person followed by the UAV. The predetermined place could be one or more hangars or squares recorded in the UAV.

As shown in FIG. 1, the UAV flying method includes the following steps: in step S10, triggering the UAV into a hijacked mode; in step S12, ascertaining if the UAV is capable of flying or not; and in step S14, the UAV flying to the location of the owner or to the predetermined place if the result of step S12 is yes. In this embodiment, the hijacked mode represents a status of the UAV and actions or a procedure in this status. In detail, the UAV is triggered into the hijacked mode if the UAV is captured by others or deviates from a predetermined flight path for some unexpected reasons, and then UAV executes the judgment, action, and reaction according to the procedure in the hijacked mode.

Besides, the UAV flying method further includes step S16. In step S16, the UAV sends a distress signal to the owner if the UAV is under the hijacked mode but not capable of flying, so as to assist the owner to rescue the UAV. In detail, the owner has a control interface to remotely control the UVA, and the distress signal sent from the UAV in step S16 could be transmitted to the control interface via wireless transmission to inform the owner that the UAV is under the hijacked mode. In practice, the control interface could be different types of remote controller, such as portable smart phone, tablet, notebook, or stationary computer or control system.

The distress signal sent from the UAV in step S16 could contain any information which helps the rescue, such as the present location of the UAV, images or sounds of the surroundings recorded by the UAV, the energy level of the UAV, and SOS signal. The owner might be able to determine the present location and the situation of the UAV after obtaining the information from the distress signal, and then rescue the UAV.

Therefore, in this embodiment, the UAV flies to the location of the owner or the predetermined place when the UAV is under the hijacked mode and capable of flying to avoid the loss. Besides, the UAV sends the distress signal including the present position and present status of UAV to the owner when the UAV is under the hijacked mode but not capable of flying.

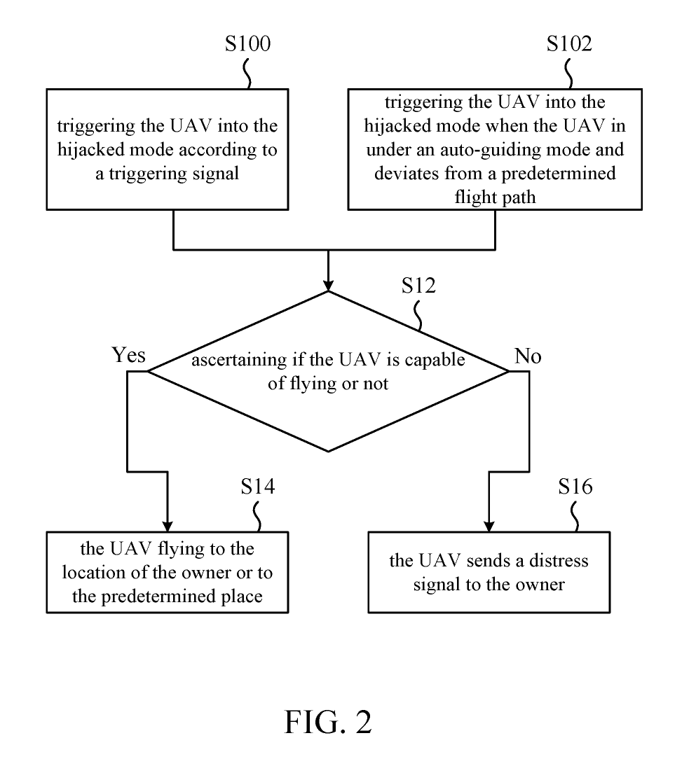

The timing for triggering the UAV into the hijacked mode could be decided by the owner or by the UAV itself. Please refer to FIG. 2. FIG. 2 is a flow chart illustrating an UAV flying method according to another embodiment of the present invention. As shown in FIG. 2, the step for triggering the UAV into the hijacked mode in this embodiment is different from that in last embodiment.

In this embodiment, the UAV flying method further includes the following steps: in step S100, triggering the UAV into the hijacked mode according to a triggering signal; and in step S102, triggering the UAV into the hijacked mode when the UAV in under an auto-guiding mode but deviates from a predetermined flight path.

In step S100, the triggering signal for triggering the UAV into the hijacked mode could be sent by the owner. For example, when the UAV is set to follow the owner, specific person or object but loses the way, the owner could send the triggering signal by the control interface via the wireless transmission. The control interface could be on the owner side so as to remote control the UAV. Besides the triggering function, the triggering signal sent by the owner could further include information of the location of the owner or the predetermined place, so that the UAV is capable of flying to the predetermined place according to the information in the following steps.

On the other hand, the UAV could be triggered into the hijacked mode by itself. In step S102, the UAV is originally under an auto-guiding mode to fly to a destination, where one or more predetermined paths could be chosen by the UAV in the auto-guiding mode. The UAV might be captured or held by someone when the UAV deviates from the predetermined flight paths, so that UAV triggers itself into the hijacked mode, and then the following steps S12, S14 or S16 would be executed to check the state of UAV, drive UAV to the location of the owner or the predetermined place, or send the distress signal.

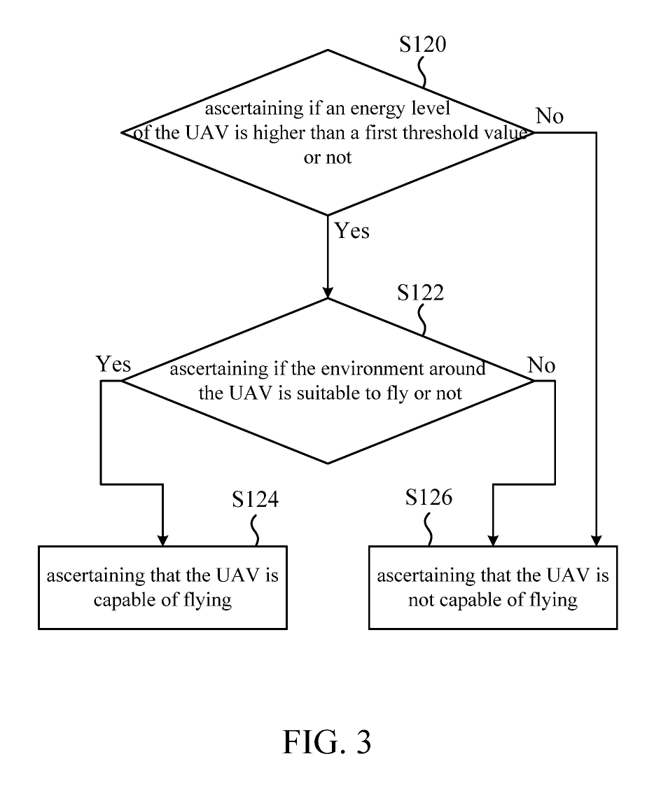

In the embodiments shown in FIG. 1 and FIG. 2, a step of ascertaining if the UAV is capable of flying or not is executed before the actions of flying back or sending the distress signal, and the step of ascertaining if the UAV is capable of flying or not could be executed according to the following embodiment. Please refer to FIG. 3. FIG. 3 is a flow chart illustrating an UAV flying method according to another embodiment of the present invention. As shown in FIG. 3, the steps of the UAV flying method in this embodiment could be the detail steps of step S12 in the above embodiments. The UAV flying method in this embodiment includes the following steps: in step S120, ascertaining if an energy level of the UAV is higher than a first threshold value or not; in step S122, ascertaining if the environment around the UAV is suitable to fly or not; in step S124, ascertaining that the UAV is capable of flying if the results of steps S120 and S122 are yes; and in step S126, ascertaining that the UAV is not capable of flying if any of the results of steps S120 and S122 is no. It should be noted that although step S120 is executed before step S122 in this embodiment, step S122 could be executed before step S120 or steps S120, S122 could be executed at the same time in practice.

In step S122, the environment around the UAV could be judged if suitable to fly or not according to how spacious the space around the UAV is. For example, in a small space such as in a car or chamber, the environment is judged as not suitable for UAV to fly; in the outdoors space, the environment is judged as suitable for UAV to fly. In practice, an optical device or an acoustic device, such as image capturing device or acoustic wave emitting device, could be installed in the UAV to detect or calculate how spacious the space around the UAV is.

In step S120, the first threshold value of energy level of the UAV could be set according to a relation among a flying distance, flying speed and energy consumption. The first threshold value could be preset in the UAV. In detail, the first threshold value of energy level of the UAV represents the distance which the UAV can fly for. The first threshold value could be configured to enable the UAV fly to afford a safe distance from the original location, so as to avoid re-capture from the captor. Besides, the first threshold value could be obtained by the UAV itself by calculating the distance between the UAV and location of the owner. For example, the UAV could receive the location of the owner from the distress signal and calculate the distance between the UAV and the location of the owner by comparing the locations, and then calculate the energy consumption required for flying for the distance. The UAV could take a certain percentage of the energy consumption (such as 60%, less than 60%, or more than 60%) as the first threshold value.

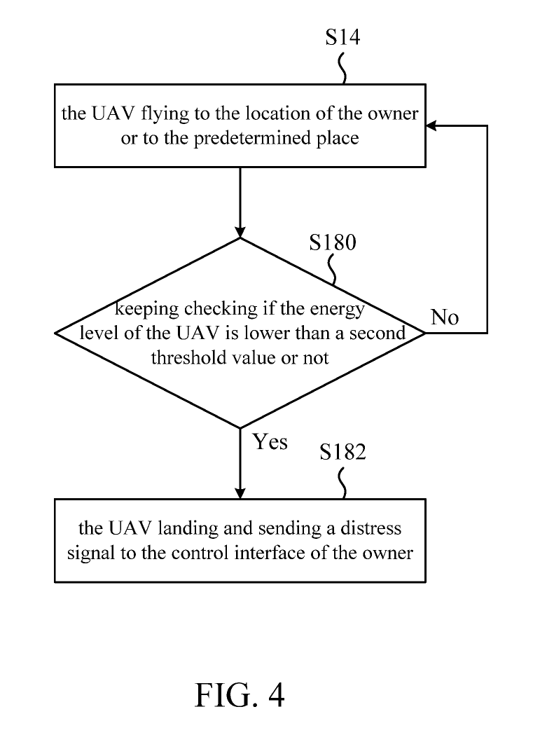

The step of ascertaining if an energy level of the UAV is higher than a first threshold value or not could be executed not only before the flight (as shown in step S120) but also during the flight in practice. Please refer to FIG. 4. FIG. 4 is a flow chart illustrating an UAV flying method according to another embodiment of the present invention. As shown in FIG. 4, the UAV flying method includes the following step after the step S14 in the above embodiment, where the UAV starts flying to the location of the owner or the predetermined place: in step S180, keeping checking if the energy level of the UAV is lower than a second threshold value or not during the flight of the UAV; and, in step S182, the UAV landing and sending a distress signal to the control interface of the owner if the result of step S180 is yes. Besides, it returns back to step S14, where the UAV flies to the location of the owner or the predetermined place, if the result of step S180 is no.

In this embodiment, the second threshold value in step S180 could be the same or not the same with the first threshold value in step S120. In step S180, the second threshold value could be set as the energy level which is higher than the energy consumption required by the UAV for landing, observing the environment, and sending the distress signal. A camera or sound recorder could be configured in the UAV for recording the images or sounds of the environment around the UAV after the UAV lands, and then the UAV could send the recorded images or sounds with the distress signal.

During the way back to the location of the owner or the predetermined place, the UAV might be stopped flying by an unusual state besides the low energy level. The unusual state includes at least one of stall, sudden drop, and imbalance of the airframe of the UAV. The unusual state might be caused by the damage to the main body or the wings of the UAV when the UAV was caught by the captor, or caused by the accidents during the auto-guiding mode, such as hitting the tree, influenced by the weather, or attacked by the birds.

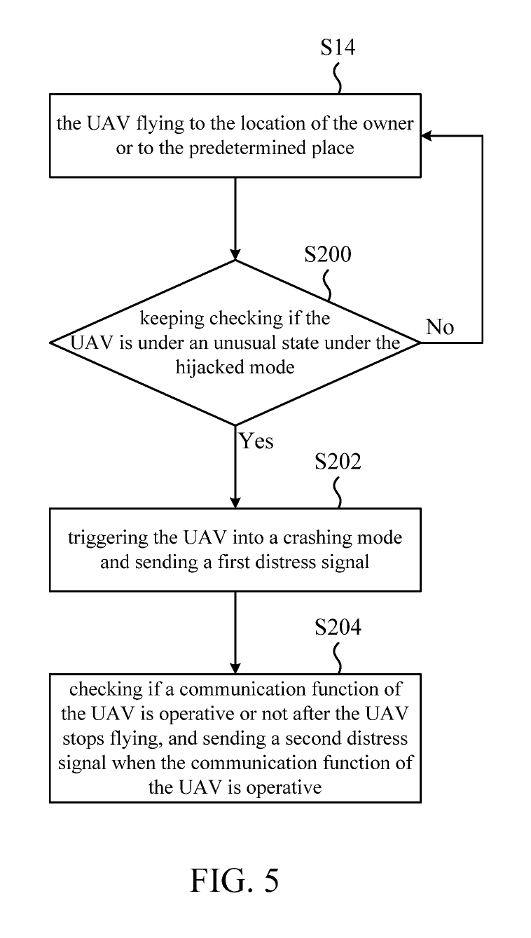

Please refer to FIG. 5. FIG. 5 is a flow chart illustrating an UAV flying method according to another embodiment of the present invention. As shown in FIG. 5, the method in this embodiment includes the following steps after the step S14 in the above embodiment, where the UAV starts flying to the location of the owner or the predetermined place: in step S200, keeping checking if the UAV is under an unusual state under the hijacked mode; in step S202, triggering the UAV into a crashing mode and sending a first distress signal if the result of step S200 is yes; and, in step S204, checking if a communication function of the UAV is operative or not after the UAV stops flying under the unusual state, and sending a second distress signal when the communication function of the UAV is operative. Besides, it returns back to step S14, where the UAV flies to the location of the owner or the predetermined place, if the result of step S200 is no.

In this embodiment, the first distress signal sent in step S200 could include the present state of the UAV, such as the present energy level, the details of the unusual state, the part in the unusual state, the location of UAV. In practice, the UAV is capable of choosing to land or to keep flying after entering the crashing mode. No matter the UAV lands or keeps flying to crash, the UAV executes step S204 to check if a communication function of the UAV is operative or not and to send the second distress signal after the UAV stops flying. The second distress signal could include the environment information around the landing or crashing location of the UAV, so as to help the owner to find the UAV.

The steps about the crashing mode (step S200 to S204) are not limited to be executed during the UAV flying back to the location of the owner or the predetermined place in practice. Those steps could be continuously executed during the normal flight of the UAV, so as to assist the owner to be aware of the unusual state of the UAV and to find the UAV easily after crashing.

Accordingly, the UAV flying method of the present invention helps the UAV to return to the location of the owner or the predetermined place from hijacked state or lost state. When the UAV is in a bad situation, such as damage on the body or low energy level, or is not capable of flying at the present location, the UAV sends the distress signal to help the owner to find the UAV according to it.

As described above, the UAV flying method of the present invention makes the UAV entering hijacked mode under the captured state or lost state, flying to the location of the owner or the predetermined place after ascertaining the present state of the UAV. Therefore, the UAV flying method is capable of avoiding or lowering the loss caused by losing the UAV or the UAV captured by the captor.

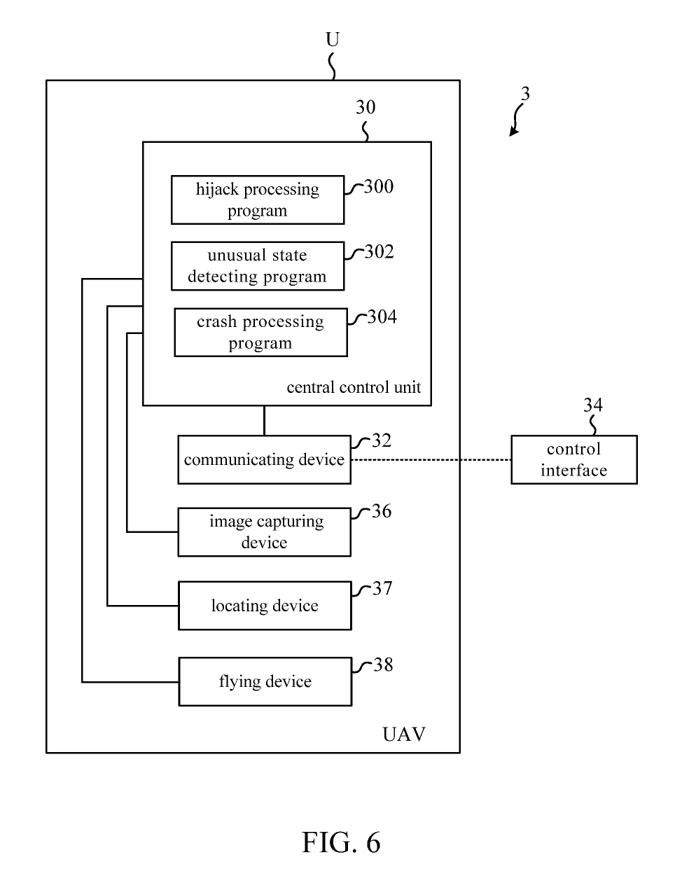

The UAV flying methods in the above-mentioned embodiments could be executed by the UAV flying system of the present invention. Please refer to FIG. 6. FIG. 6 is a schematic diagram illustrating an UAV flying system 3 according to an embodiment of the present invention. As shown in FIG. 6, the UAV flying system 3 includes a central control unit 30 configured on a UAV U to control the UAV U. A hijack processing program 300 is built in the central control unit 30, and the central control unit 30 executes a procedure as shown in the UAV flying methods in the above-mentioned embodiments according to the hijack processing program 300.

Besides the central control unit 30, the UAV flying system 3 further includes a communicating device 32 configured on the UAV U and connected to the central control unit 30, and a control interface 34 configured on the side of the owner. The communicating device 32 could be used for receiving a triggering signal sent from the control interface 34 and transmitting the triggering signal to the central control unit 30. The central control unit 30 triggers the hijack processing program 300 according to the received triggering signal.

The communicating device 32 communicates or connects the control interface 34 via any type of wireless communicating technologies, such as wireless local area network technologies of Wi-Fi or Bluetooth, or wireless wide area network technologies of 3G/4G wireless network.

The procedure executed by the central control unit 30 according to the hijack processing program 300 includes the steps described in the above-mentioned embodiment: ascertaining if an energy level of the UAV U is higher than a first threshold value or not; ascertaining if the environment around the UAV U is suitable to fly or not; controlling the UAV U flying to the location of the owner or the predetermined place if the results of the ascertaining steps are yes; and controlling the communicating device 32 to send a distress signal to the owner to assist the rescue if any of the results of the ascertaining steps is no. The distress signal includes the present position of the UAV, images or sounds of the surroundings recorded by the UAV, the energy level of the UAV, and SOS signal, so that the owner might be able to determine the present position and the situation of the UAV after obtaining the information from the distress signal.

The central control unit 30 requires the cooperation with other devices configured in the UAV to execute the procedure. As shown in FIG. 6, besides the communicating device 32, the UAV system 3 further includes an image capturing device 36, a locating device 37, and a flying device 38 configured in the UAV U. The image capturing device 36, the locating device 37, and the flying device 38 are connected to and controlled by the central control unit 30.

The central control unit 30 is capable of controlling the image capturing device 36 to capture an image of the surroundings around the UAV U at the step of ascertaining if the environment around the UAV U is suitable to fly or not executed by the central control unit 30 according to the hijack processing program 300, so as to further judge if there is enough space for flying. The central control unit 30 is also capable of attaching the image captured by the image capturing device 36 in the distress signal and sending the image with the distress signal to the owner by the communicating device 32, so as to inform the owner the conditions of the surrounding around the UAV U. The locating device 37 is capable of obtaining the present location of the UAV U, and the central control unit 30 is capable of calculating the distance between the present location UAV U and the location of the owner or the predetermined place, and the flight path. Also, the central control unit 30 is capable of attaching the present location obtained by the locating device 37 in the distress signal and sending the present location with the distress signal to the owner by the communicating device 32, so as to inform the owner where the UAV U is. The central control unit 30 could control the flying device driving the UAV U to fly to the location of the owner or the predetermined place after ascertaining that the UAV is capable of flying.

During the returning way of the UAV U, the UAV U might not reach the location of the owner or the predetermined place because of low energy level. The central control unit 30 keeps checking if the energy level of the UAV U is lower than a threshold value on the way back to the location of the owner or the predetermined place, and controls the UAV U landing and sending a distress signal to the control interface 34 on the owner side when the energy level of the UAV U is lower than the threshold value. Similarly, the central control unit 30 is capable of controlling the image capturing device 36 to capture one or more images of the surroundings around the landing point of the UAV U, and controlling the locating device 37 to obtain the landing location of the UAV U. The central control unit 30 is capable of attaching the images, the landing location, and the residual power in the distress signal, so as to inform the owner about the landing location, the present state of the UAV U, and the environment around the UAV U to assist the rescue.

Please refer to FIG. 6 again. As shown in FIG. 6, the central control unit 30 of the UAV flying system 3 further includes an unusual state detecting program 302 and a crash processing program 304. The central control unit 30 keeps checking or detecting if the UAV U is under an unusual state when the UAV U is flying. As described above, the unusual state includes at least one of stall, sudden drop, and imbalance of the airframe of the UAV U. The unusual state might be caused by the damages to the main body or the wings of the UAV when the UAV was caught by the captor, or caused by the accidents during the auto-guiding mode, such as hitting the tree, influenced by the weather, or attacked by the birds. It should be noted that the procedure of checking if the UAV U is under the unusual state executed by the central control unit 30 according to the unusual state detecting program 302 is not limited to the flight under the hijacked mode of the UAV U. The central control unit 30 could keep checking the unusual state even under the normal flight of the UAV U.

The central control unit 30 executes a crash procedure according to the crash processing program 304 once ascertaining that the UAV U is under the unusual state. In detail, the crash procedure includes sending a first distress signal once detecting the unusual state; checking if the communication function of communicating device 32 is operative or not after the UAV stops flying under the unusual state no matter the UAV U lands itself or keeps flying to crash; and sending a second distress signal by the communicating device 32 when the communication function is operative. Therefore, the owner could obtain the location of the UAV U according to the first distress signal and the second distress signal and then the rescue would be executed more smoothly and easily.

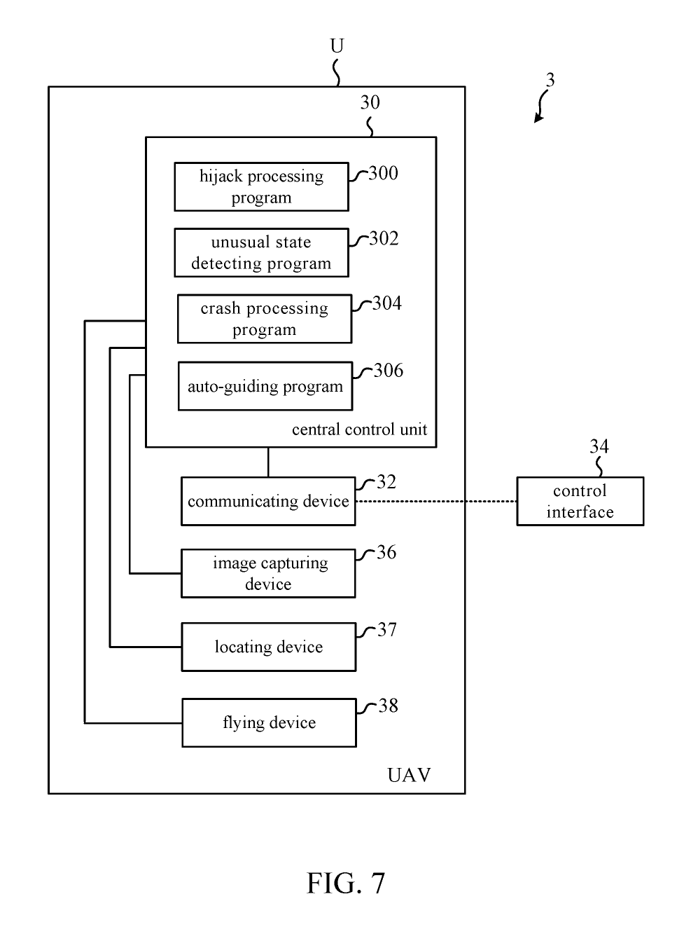

In the above-mentioned embodiment, the central control unit 30 triggers the hijack processing program 300 according to the received triggering signal, and then executes the procedure according to the hijack processing program 300. However, the central control unit 30 is capable of determining to trigger the hijack processing program 300 by itself in practice. Please refer to FIG. 7. FIG. 7 is a schematic diagram illustrating an UAV flying system 3 according to another embodiment of the present invention. As shown in FIG. 7, the difference between this embodiment and last embodiment is that the central control unit 30 further includes an auto-guiding program 306, and the central control unit 30 is capable of controlling the UAV U to fly along the predetermined flight paths. The UAV U might be captured or held by someone when the UAV U deviates from the predetermined flight paths, so that the central control unit 30 triggers the hijack processing program 300 by itself to execute the procedure.

As described above, the UAV flying system could trigger the hijack processing program when the UAV is hijacked or deviates from the predetermined flight paths. The procedure under the hijack processing program includes flying to the location of the owner or the predetermined place after ascertaining that the UAV is capable of flying, or sending the distress signal to the owner after ascertaining that the UAV is not capable of flying to assist the rescue. Therefore, the UAV flying system of the invention is capable of avoiding or lowering the loss caused by losing the UAV or the UAV being captured by the captor.

Although the present invention has been illustrated and described with reference to the preferred embodiment thereof, it should be understood that it is in no way limited to the details of such embodiment but is capable of numerous modifications within the scope of the appended claims.

What is claimed is:

1. An unmanned aerial vehicle flying method for helping an unmanned aerial vehicle (UAV) flying to a location of an owner of the UAV or flying to a predetermined place, the method comprising the following steps:
triggering the UAV into a hijacked mode;
ascertaining if the UAV is capable of flying or not; and
the UAV flying to the location of the owner or to the predetermined place if the UAV is capable of flying.

2. The method of claim 1, further comprising the following step:
triggering the UAV into the hijacked mode according to a triggering signal.

3. The method of claim 1, further comprising the following step:
triggering the UAV into the hijacked mode when the UAV deviates from a predetermined flight path.

4. The method of claim 1, further comprising the following steps:
ascertaining if an energy level of the UAV is higher than a first threshold value or not;
ascertaining if the environment around the UAV is suitable to fly or not; and
ascertaining that the UAV is capable of flying if the energy of the UAV is higher than the first threshold value and the environment around the UAV is suitable to fly.

5. The method of claim 1, further comprising the following step:
the UAV sending a distress signal to the owner if the UAV is not capable of flying.

6. The method of claim 5, wherein the distress signal comprises at least one of information of the position of the UAV, the energy level of the UAV, and the images or sounds of the surroundings recorded by the UAV.

7. The method of claim 1, further comprising the following steps:
keeping checking if the energy level of the UAV is lower than a second threshold value or not when the UAV flies under the hijacked mode; and
the UAV landing and sending a distress signal when the energy level of the UAV is lower than a second threshold value.

8. The method of claim 1, further comprising the following steps:
keeping checking if the UAV is under an unusual state under the hijacked mode;
triggering the UAV into a crashing mode and sending a first distress signal if the UAV is under the unusual state;
checking if a communication function of the UAV is operative or not after the UAV stops flying under the unusual state; and
sending a second distress signal when the communication function of the UAV is operative.

9. The method of claim 1, wherein the unusual state of the UAV includes at least one of stall, sudden drop, and imbalance of the airframe of the UAV.

10. An unmanned aerial vehicle flight system for helping an unmanned aerial vehicle (UAV) flying to the location of an owner of the UAV or flying to a predetermined place, the system comprising:
a central control unit configured on the UAV, the central control unit having a hijack processing program and executing a procedure according to the hijack processing program.

11. The system of claim 10, wherein the central control unit triggers the hijack processing program according to a triggering signal.

12. The system of claim 11, further comprising:
a communicating device configured on the UAV and connected to the central control unit, the communicating device receiving the triggering signal and transmitting the triggering signal to the central control unit.

13. The system of claim 10, further comprising:
an image capturing device configured on the UAV and connected to the central control unit, the image capturing device being capable of capturing an image of the surroundings around the UAV; and
a locating device configured on the UAV and connected to the central control unit, the locating device obtaining a location of the UAV;
wherein, the procedure further comprises sending a distress signal including the image of the surroundings and the location of the UAV to the owner.

14. The system of claim 10, further comprising:
a flying device configured on the UAV and connected to the central control unit, the flying device driving the UAV to fly;
wherein, the procedure further comprises controlling the flying device driving the UAV to fly to the location of the owner and the predetermined place.

15. The system of claim 10, wherein the procedure includes keeping checking if the energy level of the UAV is lower than a threshold value, and the UAV landing and sending a distress signal when the energy level of the UAV is lower than the threshold value.

16. An unmanned aerial vehicle flying method for helping rescue an unmanned aerial vehicle (UAV), the method comprising the following steps:
checking if the UAV is under an unusual state when the UAV is flying;
triggering the UAV into a crashing mode if the UAV is under the unusual state; and
the UAV sending the a first distress signal under the crashing mode.

17. The method of claim 16, wherein the first distress signal includes at least one of information of the position of the UAV, the energy level of the UAV, and the images or sounds of the surroundings recorded by the UAV.

18. The method of claim 16, further comprising the following steps:
checking if a communication function of the UAV is operative or not after the UAV stops flying under the crashing mode; and
sending a second distress signal when the communication function of the UAV is operative.

19. The method of claim 18, wherein the second distress signal includes at least one of information of the position of the UAV, the energy level of the UAV, and the images or sounds of the surroundings recorded by the UAV.

20. The method of claim 16, wherein the unusual state of the UAV includes at least one of stopping moving, suddenly dropping, and unbalance of the airframe of the UAV.
